(19) United States
(12) Patent Application Publication
(10) Pub. No.: US 2019/0299527 A1
(43) Pub. Date: Oct. 3, 2019

(54) THREE-DIMENSIONAL ADDITIVE MANUFACTURING APPARATUS

(71) Applicant: MITSUBISHI HEAVY INDUSTRIES, LTD., Tokyo (JP)

(72) Inventors: Masashi KITAMURA, Tokyo (JP); Koji TSUKIMOTO, Tokyo (JP); Ryuichi NARITA, Munich (DE); Michael KALMS, Bremen (DE); Claus THOMY, Bremen (DE)

(21) Appl. No.: 16/356,092

(22) Filed: Mar. 18, 2019

(30) Foreign Application Priority Data
Mar. 28, 2018 (JP) 2018-062900

(51) Int. Cl. B29C 64/268; B22F 3/105; B29C 64/153; B29C 64/371; B29C 64/277; B29C 64/386

(52) U.S. Cl. CPC B29C 64/268; B22F 3/1055; B29C 64/153; B33Y 10/00; B29C 64/277; B29C 64/386; B22F 2003/1057; B29C 64/371

(57) ABSTRACT

A three-dimensional additive manufacturing apparatus for additive manufacturing by irradiating a powder bed placed in a build surface area with is configured to project a fringe pattern over the build surface area and detect unevenness in the build surface area, based on image data obtained by capturing an image of the fringe pattern. The projection unit and the imaging unit are disposed so as to avoid an irradiation region of the beam.

### TECHNICAL FIELD

The present disclosure relates to a three-dimensional additive manufacturing apparatus for manufacturing a three-dimensional object by additive manufacturing by irradiating placed powder with a beam such as light beam or electron beam.

### BACKGROUND ART

A three-dimensional additive manufacturing technique for manufacturing a three-dimensional object by additive manufacturing by irradiating a placed powder layer with a beam such as light beam or electron beam is known. Patent Document 1 discloses an example of this type of technique, where a powder layer made of powder is irradiated with light beam to form a sintered layer, and this process is repeated to laminate multiple sintered layers to produce a three-dimensional object.

### CITATION LIST

### Patent Literature

Patent Document 1: JP2009-1900A

### SUMMARY

A three-dimensional additive manufacturing method as disclosed in Patent Document 1 involves repeated lamination of sintered layers to form a large three-dimensional object and thus takes a long operation time for completion. In particular, in case of using metal powder such as iron, copper, aluminum, or titanium, the operation time is actually several tens of hours.

Further, manufacturing process performed in this type of three-dimensional additive manufacturing method is heat process, which can cause abnormalities on a placing surface of powder or a built surface in the middle of manufacturing. For instance, if the built surface deforms so as to protrude upward, the placing surface of powder placed on the built surface becomes uneven. Further, if spatter occurs during manufacturing, the spatter may remain in a built part as a foreign matter. Such abnormalities can occur in the middle of manufacturing operation. However, there is no conventional technique for detecting the abnormalities during manufacturing operation. Therefore, after completion of a series of manufacturing operation, defective product inspection is performed to evaluate the quality of products. If an abnormality is found at inspection after manufacturing operation, the three-dimensional object having the abnormality must be disposed of as a defective product, and the long operation time spent is wasted. This prevents improvement of productivity in the three-dimensional additive manufacturing method.

At least one embodiment of the present invention was made in view of the above problem, and an object thereof is to provide a three-dimensional additive manufacturing apparatus which enables high productivity by accurately detecting an abnormality caused during manufacturing operation.

(1) To solve the above problem, according to at least one embodiment of the present invention, a three-dimensional additive manufacturing apparatus for additive manufacturing by irradiating a powder bed placed in a build surface area with a beam comprises: a projection unit configured to project a fringe pattern over the build surface area; an imaging unit configured to capture an image of the fringe pattern projected over the build surface area; and an unevenness detection unit configured to be capable of detecting unevenness in the build surface area, based on image data obtained by the imaging unit. The projection unit and the imaging unit are disposed so as to avoid an irradiation region of the beam.

With the above configuration (1), by capturing an image of the fringe pattern projected by the projection unit over the build surface area (placing surface of powder or built surface of three-dimensional object) by the imaging unit, it is possible to detect unevenness in the build surface area with the fringe projection method and examine an abnormality during manufacturing operation.

Further, with the above configuration (1), projection light emitted from the projection unit and imaging light captured by the imaging unit can be suitably separated from the beam used for building in the build surface area. Thus, it is possible to accurately detect unevenness in the build surface area.

(2) In some embodiments, in the above configuration (1), the projection unit and the imaging unit are disposed so as to avoid an operation region of a placing device for placing the powder bed.

With the above configuration (2), it is possible to accurately detect unevenness in the build surface area without physical interference of the projection unit and the imaging unit with the placing device.

(3) In some embodiments, in the above configuration (1) or (2), the projection unit and the imaging unit are set at a height of a predetermined value or more from the build surface area.

With the above configuration (3), the imaging unit for capturing an image of the fringe pattern projected over the build surface area is placed at a height of a predetermined value or more with reference to the build surface area. Thereby, for instance, it is possible to prevent interference between the imaging unit and a gas flowing in the vicinity of the build surface area for removing spatter scattered from the build surface area or fume caused from the build surface area during manufacturing operation, and it is possible to accurately detect unevenness in the build surface area.

(4) In some embodiments, in the above configuration (3), the predetermined value is an upper limit of a height at which spatter is scattered from the build surface area.

(5) In some embodiments, in the above configuration (3), the predetermined value is a height of a flow region of an inert gas disposed above the build surface area.

(6) In some embodiments, in the above configuration (5), the flow region is identifiable by positions of a first gas inlet for supplying the inert gas to the build surface area, a second gas inlet, closer than the first gas inlet to the build surface area, for supplying the inert gas to the build surface area, and a gas outlet for sucking the inert gas.

(7) In some embodiments, in any one of the above configurations (1) to (6), the imaging unit is configured to obtain imaging light via a light receiving path disposed so as to avoid a predetermined solid angular range with reference to a reflection direction of projection light from the projection unit at a center point of the build surface area.

With the above configuration (7), since the imaging unit is placed in such a position, it is possible to accurately detect unevenness in the build surface area without directly capturing the reflected light from the build surface area by the imaging unit.

(8) In some embodiments, in the above configuration (7), the predetermined solid angular range is defined by a 30-degree scattering angle with reference to the reflection direction.

With the above configuration (8), since the solid angular range is set in the above range, it is possible to favorably avoid the reflected light from the build surface area being directly captured by the imaging unit.

(9) In some embodiments, in any one of the above configurations (1) to (8), the imaging unit is configured to obtain imaging light emitted from the build surface area to the same side as an incident direction of projection light to the build surface area, with reference to a reference line defined on the build surface area so as to extend in a direction intersecting with the incident direction of the projection light at a center point of the build surface area.

With the above configuration (9), it is possible to accurately detect unevenness in the build surface area without directly capturing the reflected light from the build surface area by the imaging unit.

(10) In some embodiments, in any one of the above configurations (1) to (9), the imaging unit is disposed so as to be able to obtain imaging light emitted from the build surface area along a direction in which the powder bed is spread.

With the above configuration (10), even in a case where a groove extends along the spreading direction in the build surface area, since the imaging unit is disposed so as to be able to obtain imaging light emitted from the build surface area along the spreading direction, it is possible to suitably detect unevenness in the build surface area, while preventing the formation of dead angle zone in the build surface area.

(11) In some embodiments, in any one of the above configurations (1) to (10), the three-dimensional additive manufacturing apparatus comprises a support member mutually supporting the imaging unit; and a cooling device for cooling the support member.

With the configuration (11), although the support member mutually supporting the imaging unit is affected by heat generated during manufacturing operation, the influence of heat can be reduced or eliminated by cooling the imaging unit with the cooling device. As a result, it is possible to precisely ensure a relative positional relationship of the imaging unit during manufacturing operation, and it is possible to suitably detect unevenness in the build surface area.

(12) In some embodiments, in any one of the above configurations (1) to (11), the projection unit and the imaging unit are accommodated in a chamber in which additive manufacturing is performed on the build surface area.

With the above configuration (12), since the projection unit and the imaging unit are accommodated in the chamber in which additive manufacturing is performed on the build surface area, it is possible to achieve the above configuration with a compact and efficient structure.

(13) In some embodiments, in the above configuration (12), the projection unit and the imaging unit are fixed to a ceiling plate of the chamber.

With the above configuration (13), since the projection unit and the imaging unit are fixed to the ceiling plate of the chamber, it is possible to accurately detect unevenness in the build surface area.

(14) In some embodiments, in any one of the above configurations (1) to (11), the three-dimensional additive manufacturing apparatus comprises a chamber in which additive manufacturing is performed on the build surface area, and at least one of the projection unit or the imaging unit is disposed outside the chamber via a window part disposed on a wall surface of the chamber.

With the above configuration (14), at least one of the projection unit or the imaging unit may be disposed outside the chamber in which additive manufacturing is performed. In this case, the projection unit emits projection light to the build surface area via the window part disposed on the wall surface of the chamber, and the imaging unit captures imaging light from the build surface area via the window part.

According to at least one embodiment of the present invention, there is provided a three-dimensional additive manufacturing apparatus which enables high productivity by accurately detecting an abnormality caused during manufacturing operation.

### BRIEF DESCRIPTION OF DRAWINGS

FIG. 1 is a schematic overall configuration diagram of a three-dimensional additive manufacturing apparatus 1 according to at least one embodiment of the present invention.

FIG. 2 is a schematic diagram showing an internal configuration of a beam emission unit in FIG. 1.

FIG. 3 is a schematic configuration diagram of a shape measurement device in FIG. 1.

FIG. 4 is a schematic side view showing a configuration example of the shape measurement device of FIG. 3.

FIG. 5 is a schematic side view showing another configuration example of the shape measurement device of FIG. 3.

FIG. 6 is a schematic side view showing still another configuration example of the shape measurement device of FIG. 3.

FIG. 7 is a modified example of FIG. 6.

FIG. 8 is a schematic top view showing a configuration example of the shape measurement device of FIG. 3.

FIG. 9 is a schematic top view showing another configuration example of the shape measurement device of FIG. 3.

FIG. 10 is a schematic top view showing still another configuration example of the shape measurement device of FIG. 3.

FIG. 11 is an enlarged cross-sectional view taken along line A-A in FIG. 10.

FIG. 12 is a schematic diagram showing a pair of imaging units mutually supported by a support member.

FIG. 13 is a schematic side view showing still another configuration example of the shape measurement device of FIG. 3.

FIG. 14 is a flowchart showing each step of control for a three-dimensional additive manufacturing apparatus according to some embodiments of the present invention.

### DETAILED DESCRIPTION

Embodiments of the present invention will now be described in detail with reference to the accompanying drawings. It is intended, however, that unless particularly identified, dimensions, materials, shapes, relative positions and the like of components described in the embodiments shall be interpreted as illustrative only and not intended to limit the scope of the present invention.

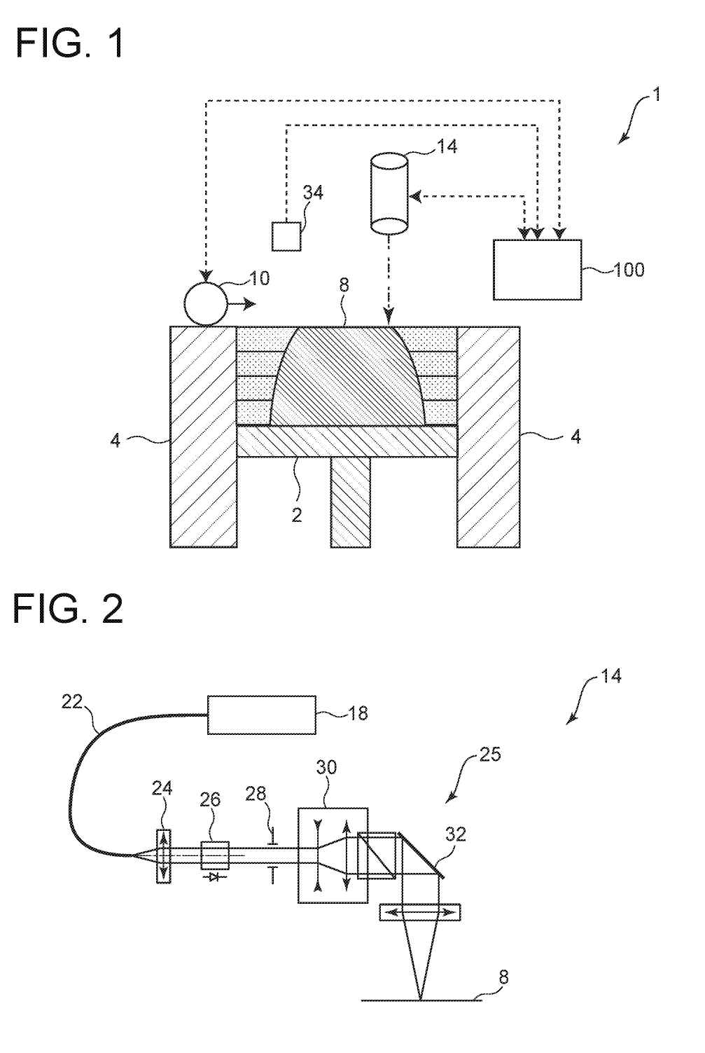

FIG. 1 is a schematic overall configuration diagram of a three-dimensional additive manufacturing apparatus 1 according to at least one embodiment of the present invention.

A three-dimensional additive manufacturing apparatus 1 is an apparatus for manufacturing a three-dimensional object by additive manufacturing by irradiating a placed powder layer with a beam. The three-dimensional additive manufacturing apparatus 1 includes a base plate 2 serving as a base on which a three-dimensional object is built. The base plate 2 is disposed so as to be vertically movable within a cylinder 4 having a substantially cylindrical shape with a central axis along the vertical direction. As described later, powder is placed on the base plate 2 to form a powder bed 8. The powder bed 8 is newly formed by placing powder on a top layer every time the base plate 2 lowers in each cycle.

Although, in the three-dimensional additive manufacturing apparatus 1 according to the present embodiments, light beam is emitted as the beam, the concept of the present invention is also applicable to the case of using beam in another form such as electron beam.

The three-dimensional additive manufacturing apparatus 1 includes a powder placing unit 10 for placing powder on the base plate 2 to form a powder bed 8. The powder placing unit 10 supplies powder over the upper surface of the base plate 2 and levels the surface to form a layered powder bed 8 having a substantially uniform thickness over the upper surface of the base plate 2. The powder bed 8 formed in each cycle is selectively solidified by a beam emitted from a beam emission unit 14 described later, and in the next cycle, powder is placed again on a top layer by the powder placing unit 10 to form a new powder bed, thereby stacking layers.

The powder supplied from the powder placing unit 10 is a powdered substance which is the raw material of the three-dimensional object. For instance, metallic materials such as iron, copper, aluminum, or titanium or non-metallic materials such as ceramic can be widely used.

The three-dimensional additive manufacturing apparatus 1 includes a beam emission unit 14 for emitting a beam to the powder bed 8 to selectively solidify the powder bed 8. FIG. 2 is a schematic diagram showing an internal configuration of the beam emission unit 14 in FIG. 1. The beam emission unit 14 includes a light source 18 for outputting laser light as the beam, an optical fiber 22 for guiding the beam from the light source to a light-condensing part 25, and a light-condensing part 25 including a plurality of optical elements.

In the light-condensing part 25, the beam guided by the optical fiber 22 enters a collimator 24. The collimator 24 focuses the beam into collimated light. The light emitted from the collimator 24 enters a beam expander 30 via an isolator 26 and a pinhole 28. The beam is expanded by the beam expander 30, then deflected by a galvano mirror 32 which is rotatable in any direction, and directed to the powder bed 8 via a fθ lens 33.

The beam may be directed from the galvano mirror 32 to the powder bed 8 without passing through the fθ lens 33.

The beam emitted from the beam emission unit 14 is scanned over the powder bed 8 along the surface of the powder bed 8 in a two-dimensional manner. Such two-dimensional scanning of the beam is performed in a pattern corresponding to the three-dimensional object to be manufactured. More specifically, the scanning is performed by drive control of the angle of the galvano mirror 32.

The two-dimensional scanning of the beam may be performed by, for instance, moving the beam emission unit 14 in parallel along the surface of the base plate 2 with a driving mechanism (not shown) or may be performed in combination with the angle drive control of the galvano mirror 32.

In the three-dimensional additive manufacturing apparatus 1 having the above configuration, in each cycle, in response to a control signal from a control device 100 which is a control unit (e.g., computing device such as computer), the powder placing unit 10 places powder on the base plate 2 to form a powder bed 8, and second-dimensional scanning is performed while the beam emission unit 14 emits a beam to the powder bed 8 to selectively solidify powder contained in the powder bed 8. In manufacturing operation, solidified layers are laminated by repeating such cycle to produce a target three-dimensional object.

Referring to FIG. 1 again, the three-dimensional additive manufacturing apparatus 1 includes a shape measurement device 34 for monitoring the shape of the powder bed 8 or the built surface (surface irradiated with beam) during manufacturing operation. In the present embodiments, an optical scanner based on the fringe projection method is used as an example of the shape measurement device 34.

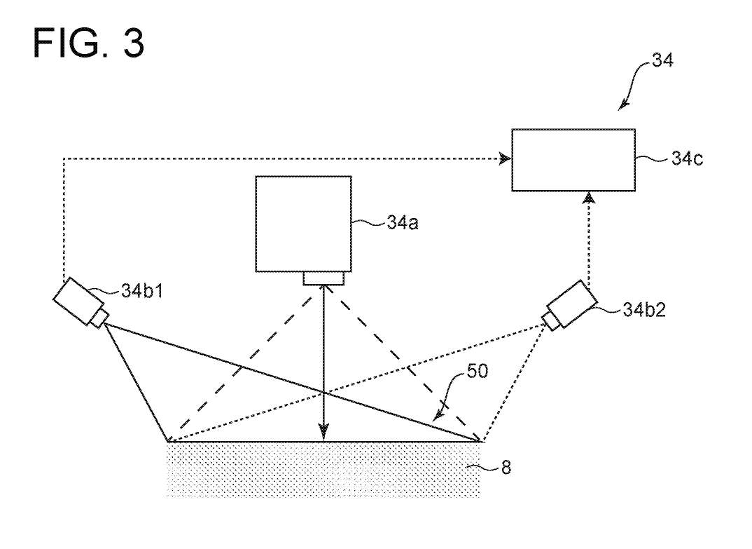

FIG. 3 is a schematic configuration diagram of the shape measurement device 34 in FIG. 1. The shape measurement device 34 includes a projection unit 34a, which is a projector, configured to project a fringe pattern over a build surface area (powder bed 8 or built surface) 50 on the base plate 2, a pair of imaging units 34b1 and 34b2 configured to capture an image of the fringe pattern projected over the build surface area 50, and an unevenness detection unit 34c capable of detecting unevenness in the build surface area 50, based on image data obtained by the pair of imaging units 34b1 and 34b2.

Although in the present embodiments, the imaging unit for capturing an image of the fringe pattern is a pair of imaging units 34b1 and 34b2, the imaging unit may be either one of them (may be single). That is, the imaging unit may be at least one imaging unit.

The pair of imaging units 34b1 and 34b2 is a stereo camera capable of obtaining a stereoscopic visual field by overlapping respective imaging ranges. In the stereoscopic visual field, a fringe patter is projected by the projection unit 34a so as to overlap. The unevenness detection unit 34c is an image analysis device capable of evaluating unevenness in the build surface area 50 by analyzing a stereo image obtained by the pair of imaging units 34b1 and 34b2 and is configured by a processing device such as a computer, for instance. In the unevenness detection unit 34c, second-dimensional images obtained by the pair of imaging units 34b1 and 34b2 are converted to an independent three-dimensional coordinate system for each pixel, based on optical conversion formula, to calculate unevenness shape in the build surface area 50.

The unevenness detection unit 34c may be a part of the control device 100 shown in FIG. 1 or may be separate from the control device 100.

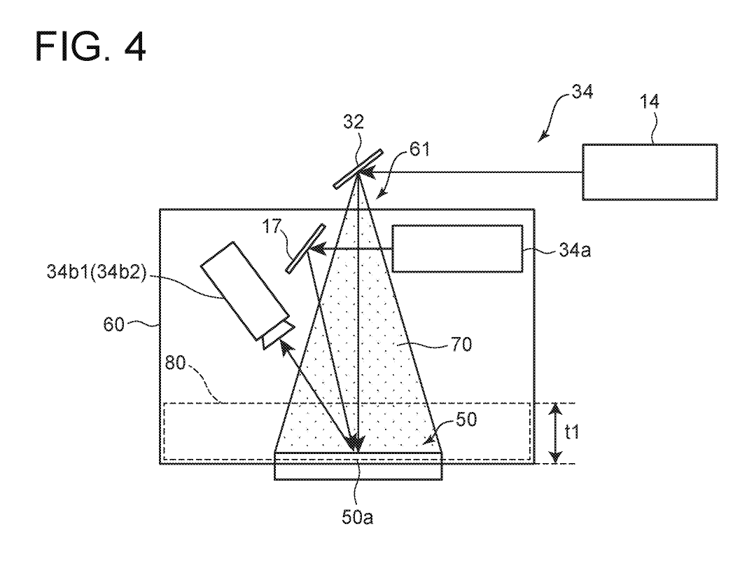

FIG. 4 is a schematic side view showing a configuration example of the shape measurement device 34 of FIG. 3.

The projection unit 34a and the pair of imaging units 34b1, 34b2 of the shape measurement device 34 are accommodated in a chamber 60 in which additive manufacturing is performed on the build surface area 50. Into the chamber 60, a beam is introduced from the beam emission unit 14 via a window part 61 disposed at an upper portion of the chamber 60 and is directed to the build surface area 50 disposed at a bottom portion of the chamber 60. The beam from the beam emission unit 14 is two-dimensionally scanned over the build surface area 50 in accordance with the angle of the galvano mirror 32.

In this way, the projection unit 34a and the pair of imaging units 34b1, 34b2 are accommodated in the chamber 60 in which additive manufacturing is performed on the build surface area 50, and thus have a compact and efficient structure. Further, since projection light from the projection unit 34a can reach the build surface area 50 without transmitting the light through a protective glass or the like, it is possible to achieve high measurement accuracy with less attenuation. Further, since the pair of imaging units 34ba, 34b2 can obtain imaging light from the build surface area 50 without transmitting the light through a protective glass or the like, it is possible to achieve high measurement accuracy with less attenuation.

The projection unit 34a and the pair of imaging units 34b1, 34b2 accommodated in the chamber 60 may be disposed relatively in the vicinity of the ceiling in an interior space of the chamber 60, as shown in FIG. 4. In this case, it is possible to ensure a distance from the build surface area 50, on which heat is generated during manufacturing, to the projection unit 34a or the pair of imaging units 34b1, 34b2. Thus, it is possible to reduce the influence of heat from the build surface area 50.

The projection unit 34a and the pair of imaging units 34b1, 34b2 accommodated in the chamber 50 are disposed so as to avoid an irradiation region 70 of the beam emitted from the beam emission unit 14. The beam emission unit 14 has the irradiation region 70 having a substantially pyramid shape whose apex is the galvano mirror 32, by controlling the angle of the galvano mirror 32, as described above. The projection unit 34a is placed sideways so that the longitudinal direction of the projection unit 34a is substantially parallel to the build surface area 50, and is configured so that projection light reflected by a projector mirror 17 disposed on the optical axis of the projection unit 34a is incident on the build surface area 50.

Although a part of an optical path from the projection unit 34a to the projector mirror 17 traverses the irradiation region 70 of the beam emission unit 14, since the projection unit 34a is disposed outside the irradiation region 70, it is possible to favorably separate projection light from the projection unit 34a and the beam emitted from the beam emission unit 14. The pair of imaging units 34b1, 34b2 is also disposed outside the irradiation region 70 of the beam emission unit 14, and optical axes of the imaging units 34b1, 34b2 are directed to a center point 50a of the build surface area 50. Thereby, it is possible to favorably separate imaging light captured by the pair of imaging units 34b1, 34b2 from the beam emitted from the beam emission unit 14.

Although the present embodiments show a layout in which imaging light from the build surface area 50 is directly captured by the pair of imaging units 34b1, 34b2, it may be configured so that imaging light from the build surface area 50 is captured by the pair of imaging units 34b1, 34b2 via an optical element such as a lens or a mirror.

Thus, since the projection unit 34a and the pair of imaging units 34b1, 34b2 are disposed so as to avoid the irradiation region 70 of the beam emission unit 14, projection light emitted from the projection unit 34a and imaging light captured by the pair of imaging units 34b1, 34b2 can be suitably separated from the beam used for building in the build surface area 50, and it is possible to accurately detect unevenness in the build surface area 50.

Further, the projection unit 34a and the pair of imaging units 34b1, 34b2 are disposed so as to avoid an operation region 80 of the powder placing unit 10 (see FIG. 1) for placing the powder bed 8. In FIG. 4, the operation region 80 of the powder placing unit 10 is shown by the dotted line. The operation region 80 is defined as a range of a height t1 from the build surface area 50. The projection unit 34a and the pair of imaging units 34b1, 34b2 are disposed at the height h or more away from the build surface area. Thereby, it is possible to accurately detect unevenness in the build surface area 50 without physical interference of the projection unit 34a and the pair of imaging units 34b1, 34b2 with the powder placing unit 10.

Although, in the present embodiments, the powder placing unit 10 for placing powder over the whole of the build surface area 50 is shown as an example of the powder placing device for forming the powder bed 8, the apparatus may further include a unit for placing powder locally over a part of the build surface area 50. In this case, by placing the projection unit 34a and the pair of imaging units 34b1, 34b2 so as to avoid the operation region of the unit capable of locally placing powder, it is possible to accurately detect unevenness in the build surface area 50 without physical interference likewise.

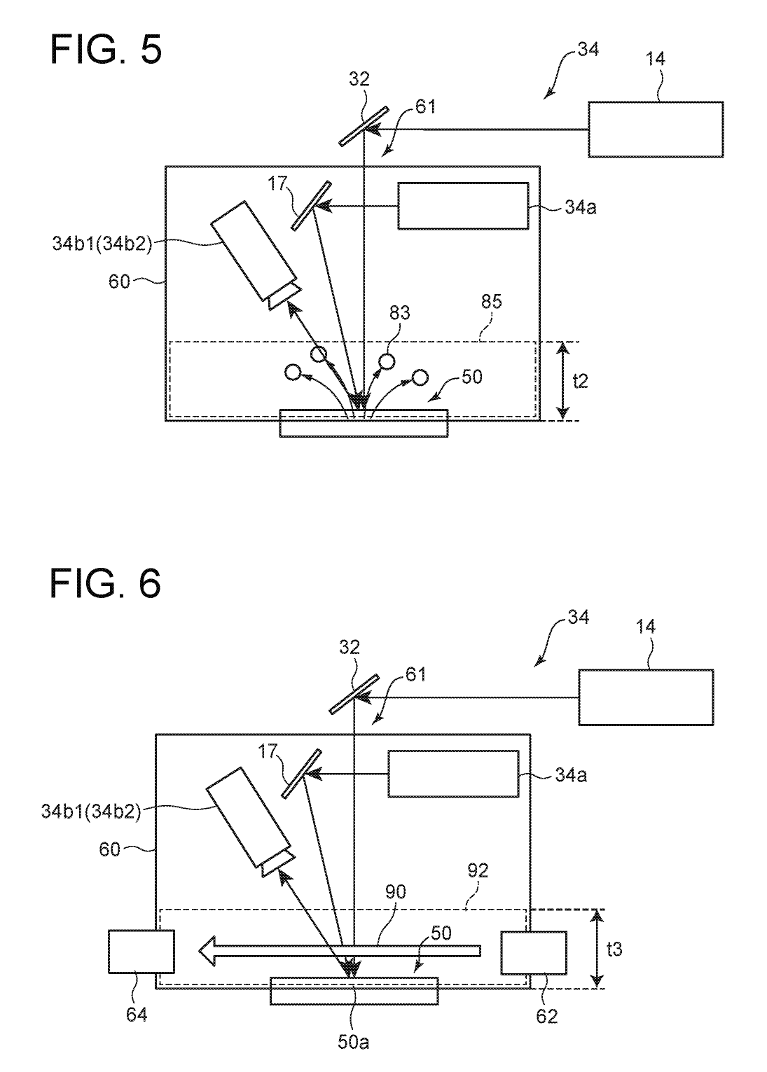

FIG. 5 is a schematic side view showing another configuration example of the shape measurement device 34 of FIG. 3.

In this configuration example, the projection unit 34a and the pair of imaging units 34b1, 34b2 are set at a height t2 or more from the build surface area 50. In manufacturing operation during which the beam is emitted from the beam emission unit 14, spatter 83 may occur from the build surface area 50. Such spatter 83 reaches a range 85 of the upper limit height t2 from the build surface area 50. In view of this, in this configuration example, the projection unit 34a and the pair of imaging units 34b1, 34b2 are disposed so as to avoid the range 85 of the upper limit height t2 at which the spatter 83 is scattered. Thereby, it is possible to accurately detect unevenness in the build surface area 50 without an influence of the spatter 83 scattered from the build surface area 50 during manufacturing operation (e.g., damage can occur when the projection unit 34a and the pair of imaging units 34b1, 34b2 exposed to the spatter 83).

FIG. 6 is a schematic side view showing another configuration example of the shape measurement device 34 of FIG. 3.

In the chamber 60 in which manufacturing operation is performed, an inert gas 90 is introduced to enhance the quality of manufacturing. The chamber 60 has a gas inlet 62 and a gas outlet 64 for the inert gas 90, and the flow of the inert gas 90 from the gas inlet 62 toward the gas outlet 64 is formed therein. In FIG. 6, the gas inlet 62 and the gas outlet 64 are separately disposed in the vicinity of the build surface area 50 (bottom side of the chamber 60), and a flow region 92 of the inert gas 90 is formed over a range of a height t3 from the build surface area 50. In this configuration example, by placing the projection unit 34a and the pair of imaging units 34b1, 34b2 so as to avoid the flow region 92, it is possible to accurately detect unevenness in the build surface area 50 without influence of the flow of the inert gas 90 from the gas inlet 62 to the gas outlet 64. For instance, it is possible to prevent variation in quality of manufacturing caused by non-uniform scattering of the spatter 83 (see FIG. 5) due to a non-uniform flow of the inert gas 90 colliding with the projection unit 34a and the pair of imaging units 34b1, 34b2.

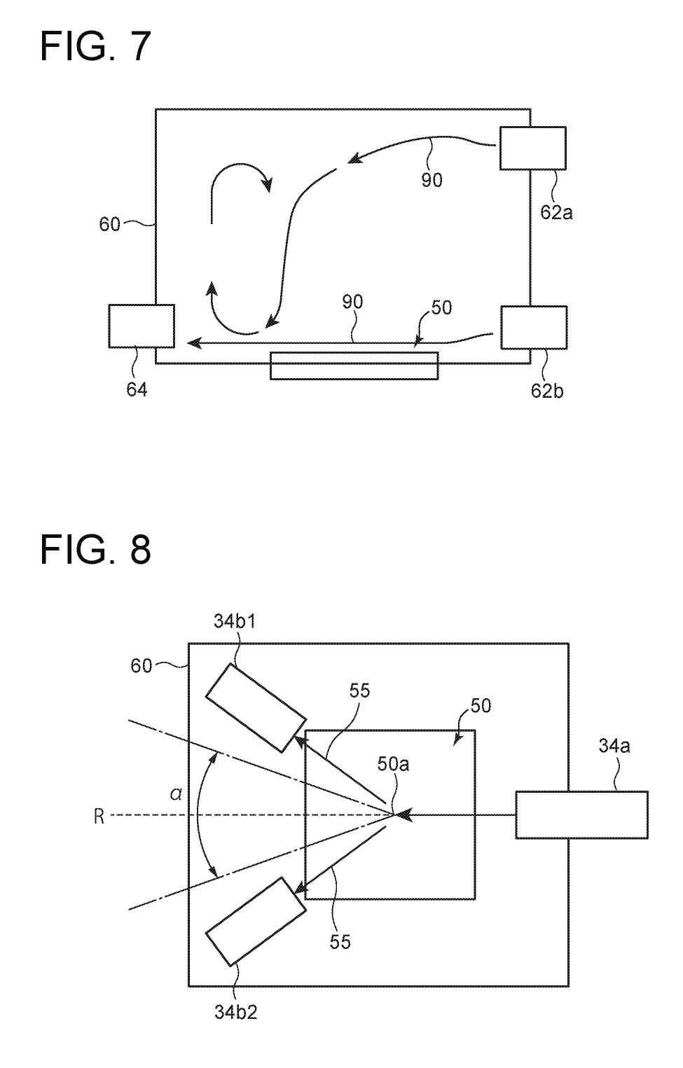

FIG. 7 is a modified example of FIG. 6. In FIG. 7, the projection unit 34a and the pair of imaging units 34b1, 34b2 disposed in the chamber 60 are not depicted for easy understanding of the flow of the inert gas.

In this modified example, the chamber includes a first gas inlet 62a positioned away from the build surface area 50 (in the vicinity of the ceiling of the chamber 60), and a second gas inlet 62b positioned adjacent to the build surface area 50 (in the vicinity of the bottom of the chamber 60). In this case, the flow region 92 of the inert gas 90 may be determined by identifying the flow of the inert gas 90 in the chamber 60 based on positions of the first gas inlet 62a, the second gas inlet 62b, and the gas outlet 64, and the projection unit 34a and the pair of imaging units 34b1, 34b2 may be disposed so as to avoid the flow region 92 thus determined.

The flow region 92 of the inert gas 90 in the chamber 60 can be determined by various simulation, theoretical or experimental methods.

FIG. 8 is a schematic top view showing a configuration example of the shape measurement device 34 of FIG. 3.

When projection light is emitted from the projection unit 34a to a built surface formed in the build surface area 50 by beam irradiation, the projection light is reflected by the built surface which is mirrored. If the reflected light is directly captured by the pair of imaging units 34b1, 34b2, there is a risk of reducing the quality of imaging the build surface area 50.

Then, in this configuration example, the pair of imaging units 34b1, 34b2 is configured to obtain imaging light via a light-receiving path 55 disposed so as to avoid a predetermined solid angular range α with reference to a reflection direction R of projection light from the projection unit 34a at a center point 50a of the build surface area 50. In this embodiment, particularly, the solid angular range α is defined by a 30-degree scattering angle with reference to the reflection direction. By placing the pair of imaging units 34b1, 34b2 so as to avoid the solid angular range α, it is possible to accurately detect unevenness in the build surface area 50 without directly capturing the reflected light from the build surface area 50 by the pair of imaging units 34b1, 34b2.

In this configuration example, as long as the light-receiving path 55 closest to the build surface area 50 is configured to avoid the solid angular range α, an optical path on the downstream side (i.e., on the side adjacent to the pair of imaging units 34b1, 34b2) of this portion may be configured freely by an optical element such as a mirror or a lens.

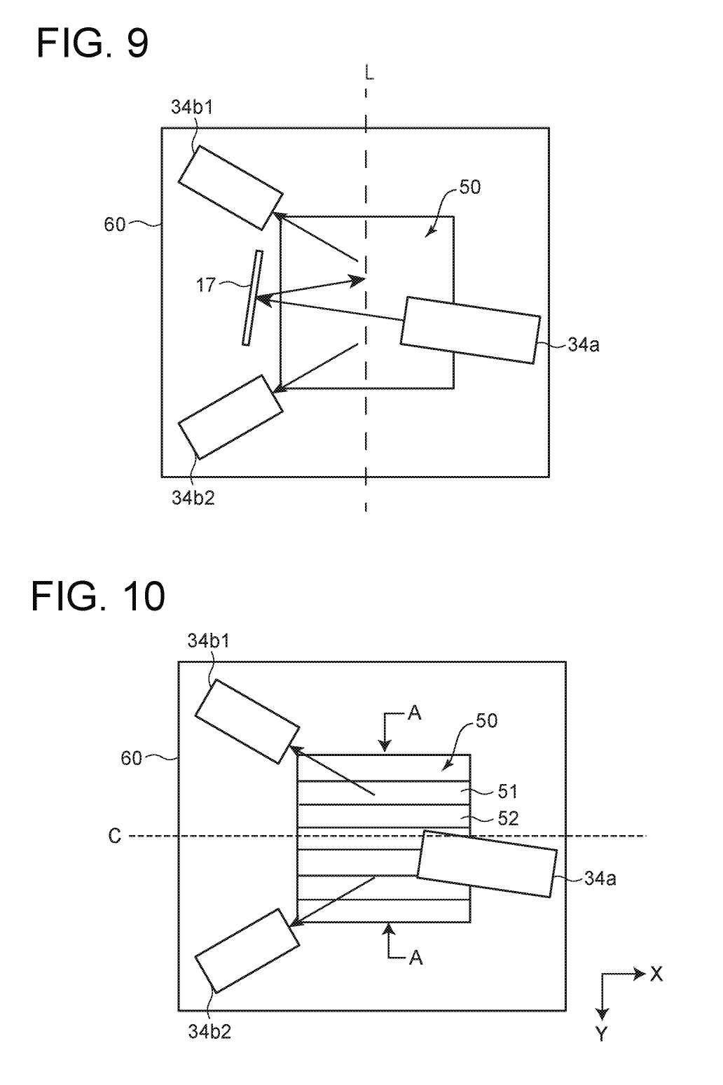

FIG. 9 is a schematic top view showing another configuration example of the shape measurement device 34 of FIG. 3. FIG. 9 corresponds to the configuration example shown in FIG. 6 in side view.

In this configuration example, the pair of imaging units 34b1, 34b2 is configured to obtain imaging light emitted from the build surface area 50 to the same side as an incident direction of projection light to the build surface area 50, with reference to a reference line L defined on the build surface area 50. The reference line L is defined on the build surface area 50 so as to extend in a direction intersecting with the incident direction of projection light at the center point 50a of the build surface area 50. That is, it is arranged so that projection light incident on the build surface area 50 and imaging light emitted from the build surface area 50 are on the same side of the reference line L when viewed from the build surface area 50. In this case, similarly, it is possible to accurately detect unevenness in the build surface area 50 without directly capturing the reflected light from the build surface area 50 by the pair of imaging units 34b1, 34b2.

In this configuration example, as long as the emission direction of imaging light from the build surface area 50 and the incident direction of projection light to the build surface area 50 are on the same side of the reference line L, the imaging light emitted from the build surface area 50 may have any optical path with an optical element such as a mirror or a lens, on the downstream side (i.e., on the side adjacent to the pair of imaging units 34b1, 34b2).

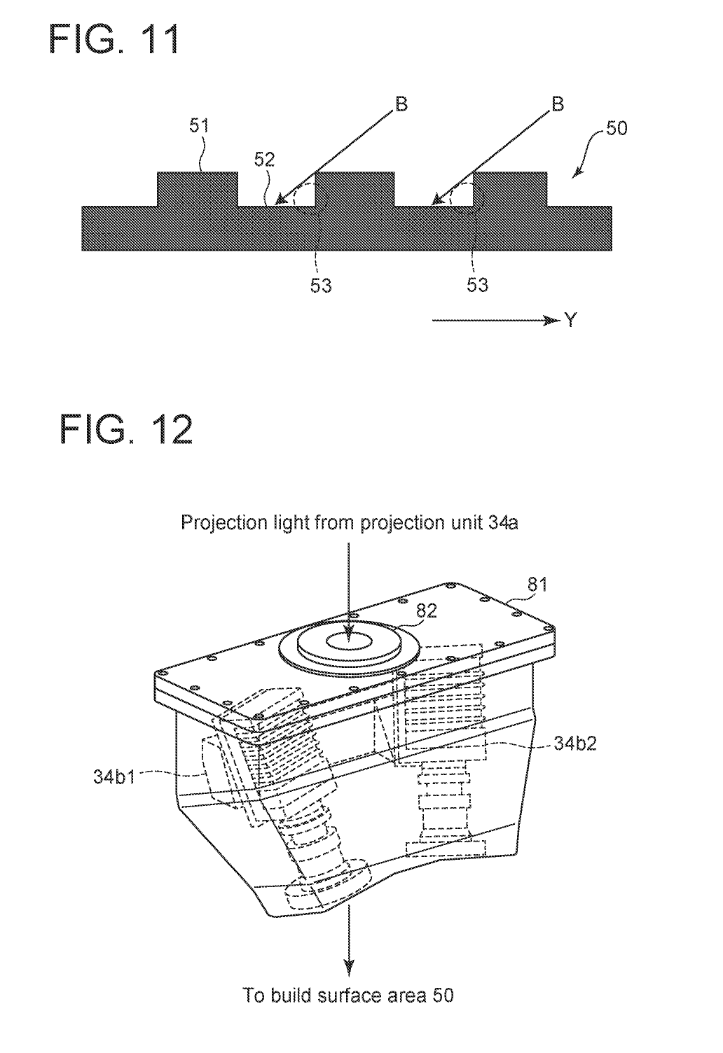

FIG. 10 is a schematic top view showing still another configuration example of the shape measurement device 34 of FIG. 3. FIG. 11 is an enlarged cross-sectional view taken along line A-A in FIG. 10.

In this configuration example, a built surface formed by additive manufacturing by irradiating the powder bed 8 with the beam exists in the build surface area 50 defined in an XY plane on the base plate 2. The built surface has an uneven shape extending along a predetermined direction X. In this case, as shown in FIG. 11, the surface of the build surface area 50 has a cross-sectional shape in which projections 51 and recesses 52, each of which extends along the X direction, are alternated with each other along the Y direction. Thus, if an image of the build surface area 50 is captured from a B direction along the Y axis, a dead angle zone 53 is formed by the projection 51 and the recess 52, and an image of a part of the build surface area 50 cannot be captured.

Then, in this configuration example, as shown in FIG. 10, the pair of imaging units 34b1, 34b2 is disposed at a position enabling the imaging units to obtain imaging light emitted from the build surface area 50 along the X axis, which is parallel to the extending direction of the uneven shape. In other words, the pair of imaging units 34b1, 34b2 is disposed on both sides of a center line C of the build surface area 50 along the X direction. By placing the pair of imaging units 34b1, 34b2 in this way, the dead angle zone 53 on the build surface area 50 is reduced, enabling accurate measurement.

Although in this configuration example, the position of the pair of imaging units 34b1, 34b2 is determined with reference to the extending direction of the uneven shape of the built surface in the build surface area 50, the pair of imaging units 34b1, 34b2 may be positioned based on an extending direction of an uneven shape on the powder bed 8 before irradiation with the beam (e.g., a direction in which powder is spread by the powder placing unit).

Further, in some embodiments, as shown in FIG. 12, the pair of imaging units 34b1, 34b2 may be accommodated in the chamber 60 while a support member 81 mutually supports the imaging units 34b1, 34b2. FIG. 12 is a schematic diagram showing the pair of imaging units 34b1, 34b2 mutually supported by a support member 81.

In the present embodiment, the support member 81 is configured as a casing surrounding the pair of imaging units 34b1, 34b2. The support member 81 supports the pair of imaging units 34b1, 34b2 in a predetermined orientation so as to achieve the positional relationship described herein with respect to the pair of imaging units 34b1, 34b2. The support member 81 is accommodated in the chamber 60 in which manufacturing operation is performed, and is configured to be fixable to an inner wall of the chamber 60.

Additionally, the support member 81 has a hole part 82 allowing projection light from the projection unit 34a to pass through. Although not depicted in FIG. 12, the projection unit 34a is disposed on one side of the hole part 82, and projection light emitted from the projection unit 34a passes through the hole part 82 and is projected on the build surface area 50 on the other side of the hole part 82. Such a hole part 82 is provided in accordance with the positional relationship described herein with respect to the projection unit 34a and the pair of imaging units 34b1, 34b2 in the chamber 60.

As described above, since the support member 81 supporting the pair of imaging units 34b1, 34b2 is disposed in the chamber 60, deformation such as thermal expansion may occur due to the influence of heat generated during manufacturing operation, and thus there is a risk that the relative positional relationship of the pair of imaging units 34b1, 34b2 is deviated from the initial position by the support member 81. In view of this, in some embodiments, the support member 81 may have a cooling mechanism to prevent reduction in detection accuracy.

As examples of the support member 81 having a cooling mechanism, for instance, the support member 81 may be made of a material having excellent heat dissipation. Further, the support member 81 may be provided with a heat dissipation member having more excellent heat dissipation than the main body of the support member 81. Such a support member 81 and a heat dissipation member may have a heat sink shape which facilitates heat dissipation to ensure a wide thermal contact area. Further, the support member 81 may have a cooling device to which a coolant is supplied. In this case, for instance, the cooling device may be water cooling device using cooling water as the coolant, or may be a blowing device using cooling air as the coolant.

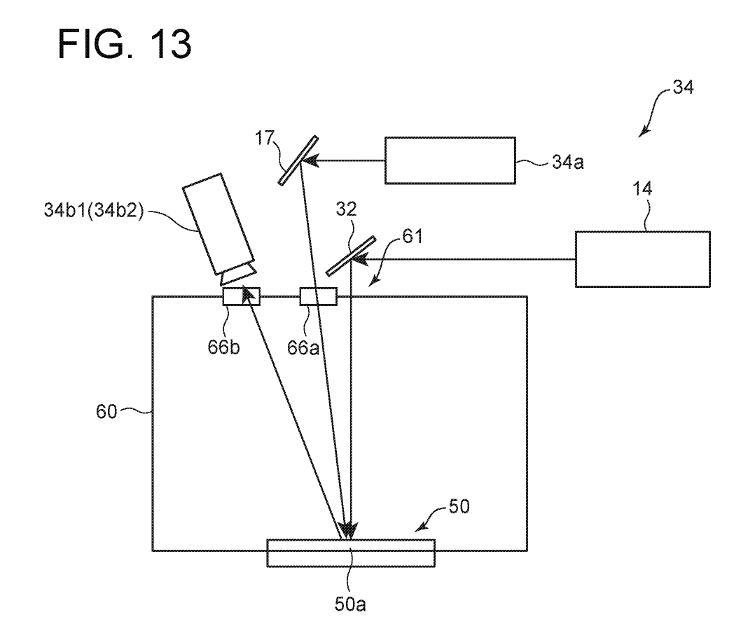

FIG. 13 is a schematic side view showing still another configuration example of the shape measurement device 34 of FIG. 3.

Although the above-described configuration examples show the cases where the projection unit 34a and the pair of imaging units 34b1, 34b2 constituting the shape measurement device 34 are accommodated in the chamber 60 in which additive manufacturing is performed on the build surface area 50, at least a part of the projection unit 34a and the pair of imaging units 34b1, 34b2 may be disposed outside the chamber 60 as shown in the following configuration example.

In this configuration example, the projection unit 34a and the pair of imaging units 34b1, 34b2 are disposed outside the chamber 60 in which additive manufacturing is performed on the build surface area 50. Projection light emitted from the projection unit 34a is configured so that the projection light can enter the interior of the chamber 60 via a window part 66a disposed on the wall surface of the chamber 60 and reach the build surface area 50. Further, imaging light from the build surface area 50 is configured so that the imaging light can reach the pair of imaging units 34b1, 34b2 disposed outside the chamber 60 via a window part 66b disposed on the wall surface of the chamber 60.

The window parts 66a, 66b have a configuration capable of transmitting light, such as a lens. In this case, the window parts 66a, 66b are preferably configured to minimize attenuation of transmitted light. In such a configuration example, while the projection unit 34a and the pair of imaging units 34b1, 34b2 are disposed outside the chamber, the same function can be obtained by setting their positional relationship as in the above-described embodiments.

Although the example in FIG. 13 shows the case where the whole of the projection unit 34a and the pair of imaging units 34b1, 34b2 constituting the shape measurement device 34 are disposed outside the chamber 60, only a part of the projection unit 34a and the pair of imaging units 34b1, 34b2 may be disposed outside the chamber 60.

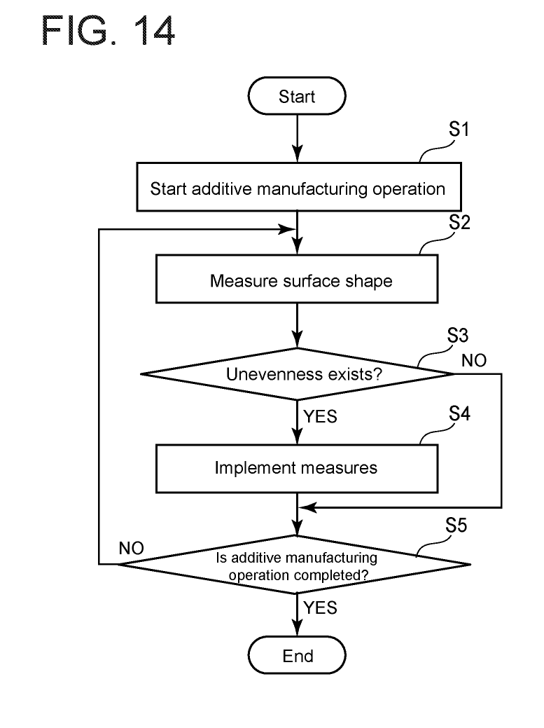

Next, a control example of the three-dimensional additive manufacturing apparatus 1 having the above configuration will be described. FIG. 14 is a flowchart showing each step of control for a three-dimensional additive manufacturing apparatus 1 according to some embodiments of the present invention.

First, the three-dimensional additive manufacturing apparatus 1 starts additive manufacturing operation (step S1). The additive manufacturing operation proceeds by repeatedly performing a step of forming a powder bed 8 by placing (spreading) powder on the base plate 2, and a step of irradiating the powder bed 8 with a beam.

The three-dimensional additive manufacturing apparatus 1 measures the surface shape of the build surface area 50 by acquiring a measurement result from the shape measurement device 34 during additive manufacturing operation (step S2). At this time, the shape measurement device 34 measures the surface shape of the build surface area 50 as a three-dimensional structure by measurement based on the fringe projection method, as described above.

Then, the three-dimensional additive manufacturing apparatus 1 determines whether unevenness exists on the build surface area 50 based on the measurement result in step S102 (step S3). In the present embodiment, it is determined that unevenness exists when detected unevenness is out of an allowable range. The allowable range is set based on whether unevenness is a defect that is not allowable in product quality when manufacturing cycle proceeds.

If it is determined that unevenness exists on the build surface area 50 (step S3: YES), the three-dimensional additive manufacturing apparatus 1 implements various measures to improve product quality (step S4). The measures implemented in this step may be repair operation such as placing the powder bed 8 again by the powder placing unit 10 (recoater) or beam re-irradiation to the build surface area 50, or may be notification to an operator that unevenness exists on the build surface area 50. The unevenness monitoring based on the surface shape continues until additive manufacturing operation is completed (step S5).

Monitoring of the build surface area 50 by the shape measurement device 34 may be performed on the powder bed 8 before beam irradiation or may be performed on the built surface after irradiating the powder bed 8 with the beam.

As described above, the above-described three-dimensional additive manufacturing apparatus 1 monitors abnormality or unevenness, which is a sign of the abnormality, on the build surface area 50 by the shape measurement device 34. If unevenness with a size out of an allowable range is detected by the shape measurement device 34, improvement measures are implemented as appropriate, and thereby it is possible to prevent abnormality, which can become fatal as manufacturing operation proceeds, at early stage.

### INDUSTRIAL APPLICABILITY

At least one embodiment of the present invention can be applied to a three-dimensional additive manufacturing apparatus for manufacturing a three-dimensional object by additive manufacturing by irradiating spread powder with a beam such as light beam or electron beam.

1. A three-dimensional additive manufacturing apparatus for additive manufacturing by irradiating a powder bed placed in a build surface area with a beam, comprising:
a projection unit configured to project a fringe pattern over the build surface area;
an imaging unit configured to capture an image of the fringe pattern projected over the build surface area; and
an unevenness detection unit configured to be capable of detecting unevenness in the build surface area, based on image data obtained by the imaging unit,
wherein the projection unit and the imaging unit are disposed so as to avoid an irradiation region of the beam.

2. The three-dimensional additive manufacturing apparatus according to claim 1,
wherein the projection unit and the imaging unit are disposed so as to avoid an operation region of a placing device for placing the powder bed.

3. The three-dimensional additive manufacturing apparatus according to claim 1,
wherein the projection unit and the imaging unit are set at a height of a predetermined value or more from the build surface area.

4. The three-dimensional additive manufacturing apparatus according to claim 3,
wherein the predetermined value is an upper limit of a height at which spatter is scattered from the build surface area.

5. The three-dimensional additive manufacturing apparatus according to claim 3,
wherein the predetermined value is a height of a flow region of an inert gas disposed above the build surface area.

6. The three-dimensional additive manufacturing apparatus according to claim 5,
wherein the flow region is identifiable by positions of a first gas inlet for supplying the inert gas to the build surface area, a second gas inlet, closer than the first gas inlet to the build surface area, for supplying the inert gas to the build surface area, and a gas outlet for sucking the inert gas.

7. The three-dimensional additive manufacturing apparatus according to claim 1,
wherein the imaging unit is configured to obtain imaging light via a light receiving path disposed so as to avoid a predetermined solid angular range with reference to a reflection direction of projection light from the projection unit at a center point of the build surface area.

8. The three-dimensional additive manufacturing apparatus according to claim 7,
wherein the predetermined solid angular range is defined by a 30-degree scattering angle with reference to the reflection direction.

9. The three-dimensional additive manufacturing apparatus according to claim 1,
wherein the imaging unit is configured to obtain imaging light emitted from the build surface area to the same side as an incident direction of projection light to the build surface area, with reference to a reference line defined on the build surface area so as to extend in a direction intersecting with the incident direction of the projection light at a center point of the build surface area.

10. The three-dimensional additive manufacturing apparatus according to claim 1,
wherein the imaging unit is disposed so as to be able to obtain imaging light emitted from the build surface area along a direction in which the powder bed is spread.

11. The three-dimensional additive manufacturing apparatus according to claim 1, further comprising:
a support member mutually supporting the imaging unit; and
a cooling device for cooling the support member.

12. The three-dimensional additive manufacturing apparatus according to claim 1,
wherein the projection unit and the imaging unit are accommodated in a chamber in which additive manufacturing is performed on the build surface area.

13. The three-dimensional additive manufacturing apparatus according to claim 12,
wherein the projection unit and the imaging unit are fixed to a ceiling plate of the chamber.

14. The three-dimensional additive manufacturing apparatus according to claim 1, further comprising a chamber in which additive manufacturing is performed on the build surface area,
wherein at least one of the projection unit or the imaging unit is disposed outside the chamber via a window part disposed on a wall surface of the chamber.
